(19) United States
(12) Patent Application Publication
(10) Pub. No.: US 2012/0280853 A1
(43) Pub. Date: Nov. 8, 2012

(54) RADAR SYSTEM AND METHOD FOR DETECTING AND TRACKING A TARGET

(75) Inventor: Anders Silander, Goteborg (SE)

(73) Assignee: SAAB AB, Linkoping (SE)

(21) Appl. No.: 13/508,417

(22) PCT Filed: Nov. 6, 2009
(86) PCT No.: PCT/SE09/51267

§ 371 Date: Jul. 23, 2012

(51) Int. Cl. G01S 13/66

(52) U.S. Cl. 342/147

(57) ABSTRACT

A radar system for detecting and tracking at least one target utilizing a mechanically rotated two-dimensional radar antenna system with a fan-shaped beam arrangeable on a non-stable radar platform. The radar system includes a tracking filter configured to estimate an azimuth angle of the at least one target with respect to a fixed reference coordinate system based on: azimuth angle information of at least one target radar return signal measured utilizing the radar antenna system with respect to a local coordinate system of the radar platform, and radar platform relative orientation with respect to the fixed reference coordinate system at the time of the at least one target radar return signal, such that a software-based motion-compensation of the radar platform is provided.

### TECHNICAL FIELD

The present invention relates to the field of 2D search radar systems, especially for use in the maritime and aeronautical applications where weight and costs of the radar system is of importance, but also other applications where motion compensation of a radar antenna is required might be of interest.

### BACKGROUND ART

One common radar type is a radar system that can provide information of a detected target's azimuth and range. This type of radar system is often called a bidimensional (2D) radar system. By mechanically rotating the radar antenna around an axis which is orthogonal to the horizontal plane, a 2D radar system can effectively cover a 360° angle area. To adequately detect targets at different elevations, a radar antenna generating a vertical fan beam is used, i.e. a beam narrow on the azimuth plane and tall in the elevation plane. This type of radar systems are commonly used in navigation and air warning radar applications.

When a radar antenna of 2D radar system experiences roll and pitch motion, for example when arranged on a marine vessel, said radar system has problems in accurately tracking detected targets because of the varying divergence between the radar antenna's rotational axis and the orthogonal of the horizontal plane, i.e. the difference between a varying radar system's local coordinate system and a static horizontal coordinate systems.

The solution to this problem has been to arrange to the radar antenna on a servo based motion compensating support, which compensates roll and pitch motion of the radar antenna with respect to a horizontal coordinate system by means of inertial sensors, a control system and a servo system that stabilizes the orientation of the radar antenna, such that the rotating axis of the radar antenna is always orthogonal to the horizontal plane. Such a solution is for example known from patent document JP2006311187A. The present servo systems are however expensive, heavy and a potential source of unreliability.

Another disadvantage using a 2D search radar system having a vertical fan beam antenna is that it cannot provide information about target elevation, and the target data is thus limited to azimuth, range and radial velocity. When elevation information is needed, an additional height-finding radar antenna must be provided, or a different type of radar system must be used, for example phased array radar systems.

There is thus a need for an improved 2D radar system, which partly avoids the above mentioned disadvantages.

### SUMMARY

The object of the present invention is to provide a radar system for detecting and tracking at least one target by means of a mechanically rotated two-dimensional (2D)-radar antenna system with a fan-shaped beam, arrangeable on a non-stable radar platform where the previously mentioned problems are partly avoided. This object is achieved by the characterizing portion of claim 1, where said radar system comprises a tracking filter configured to estimate an azimuth angle of said at least one target with respect to a fixed reference coordinate system, preferably a fixed horizontal coordinate system, based on:
azimuth angle information of at least one target radar return signal measured by means of said radar antenna system with respect to a local coordinate system of said radar platform,
radar platform relative orientation with respect to said fixed reference coordinate system at the time of said at least one target radar return signal,
such that a software-based motion-compensation of said radar platform is provided.

The object of the present invention is also to provide a method for detecting and tracking at least one target by means of a mechanically rotated two-dimensional (2D) radar antenna system with a fan-shaped beam, arrangeable on a platform where the previously mentioned problems are partly avoided. This object is achieved by the characterizing portion of claim 6, wherein said method comprises the following steps:
obtaining azimuth angle information of at least one target radar return signal measured by means of said radar antenna system with respect to a local coordinate system of said radar platform,
obtaining radar platform relative orientation with respect to a fixed reference coordinate system at the time of said at least one target radar return signal, and
estimating an azimuth angle of said at least one target with respect to said fixed reference coordinate system by means of a tracking filter, based on said azimuth angle information and said radar platform relative orientation, such that a software-based motion-compensation of said radar platform is provided.

By means of the radar system and its corresponding method presented above, there is no longer a need to arrange the radar antenna on an expensive, heavy and complex mechanical motion compensating support. Consequently, a vehicle carrying a radar system according to the invention, and thus without a mechanical motion compensation support, will show improved dynamic performance, and have higher radar function reliability. This applies especially to radar systems arranged on marine vehicles, where the radar antenna is located at a relatively elevated position, where reduced weight has an increasingly positive impact on vehicle stability and roll motion, and to radar systems arranged on aeronautical vehicles, where reduced weight always has a positive impact on aeronautical performance.

According to a further advantageous aspect of the invention, said tracking filter is configured to estimate the elevation of said at least one target in said fixed reference coordinate system by iteratively updating a target elevation estimation by means of said tracking filter based on at least two target radar return signals, each received during separate radar measurement scans of the same target, and each received at a different relative orientation of the radar platform. Knowing the orientation of the radar platform combined with at least two azimuth angle measurements of the radar antenna, each measurement taken with the fan-shaped beam in different plane at the moment of measurement, it is possible to estimate also the elevation of a target using a 2D-antenna. The measurements in different planes are obtained by pitch and roll motion of the radar platform, and with a time period between said at least two measurements.

According to a further advantageous aspect of the invention, said radar system comprises:
a non-stable radar platform,
a mechanically rotated 2D-radar antenna system arranged on said radar platform, and configured to generate a fan-shaped beam, and to measure azimuth angle information of at least one target radar return signal with respect to a local coordinate system of said radar platform, and
radar platform orientation sensors configured to provide said radar platform relative orientation with respect to said fixed reference coordinate system.

According to a further advantageous aspect of the invention, said tracking filter is configured to estimate a range and/or radial velocity of said at least one target with respect to the said radar platform. This can be done by including target parameters range and/or radial velocity as parameters in a target state vector. Measuring and estimating range and/or radial velocity improves estimation accuracy of the tracking filter since more target parameter information is available.

According to a further advantageous aspect of the invention, the radar system comprises inertial sensors, like accelerometers, gyroscopes, inclinometers, or an inertial navigation system, for providing the relative orientation of said radar platform with respect to the fixed reference coordinate system. The accurate measurement of the platform orientation determines the tracking filter's possibility to accurately compensate for platform motion and inclination.

According to a further advantageous aspect of the invention, the radar antenna is arranged on said radar platform without mechanical motion compensation. The radar antenna is thus strapped-down onto said platform without the use a servo-based motion compensating unit. Consequently, the rotation axis of the radar antenna will deviate from the orthogonal to the horizontal plane in case the platform tilts.

According to a further advantageous aspect of the invention, the radar tracking filter is a nonlinear state estimation filter, for example an extended Kalman filter, or a particle filter. By estimating also the radar platform relative orientation with the tracking filter, said filter can concurrently take into account the uncertainty of said radar platform relative orientation measurements, as well as the measurements of the radar antenna system. This improves target position estimation in case of moving targets, and in case of multiple targets.

According to a further advantageous aspect of the invention, a measurement model of said tracking filter defines a state space S=Sₓ·S_{θ} of a detectable target, a distribution function p(tₖ,xₖ,θₖ) of the target at time tₖ taking into account all radar return signals measured up to this time, wherein S_{θ} is discretized to N discrete intervals in the vertical θ-direction of a fixed horizontal coordinate system, where Bⱼ denotes these intervals, such that S_{θ}=UⱼBⱼ. The discretization of the elevation interval provides the possibility of calculating the distribution function p(tₖ,xₖ,θₖ) using a normal distribution, which is piecewise constant for each elevation interval, even when the platform tilts and said distribution function no longer has a normal distribution.

According to a further advantageous aspect of the invention, the discretization is denser where the elevation distribution P_{θ,k}ⁱ is high and less dense where the elevation distribution P_{θ,k}ⁱ is small. This increases estimation accuracy.

According to a further advantageous aspect of the invention, the 2D-radar antenna system is configured to measure target parameters (r′,ψ′,t) in said local coordinate system of said radar platform. Said target parameters can be range to target (r′), azimuth angle to target (ψ′), and time (t) of target radar return signal. Said target parameters are subsequently transferred to said tracking filter, which is configured to produce an estimate of the state at the current time step based on a state estimate from a previous time step.

According to a further advantageous aspect of the invention, said tracking filter is configured to determine coordinate transfer functions gⱼ for all j, and transform measured target parameters (r′,ψ′,t) in said local coordinate system to target parameters (r,ψ,Θⱼ,t) in said fixed reference coordinate system for all different Θⱼ by means of said coordinate transfer functions gⱼ.

According to a further advantageous aspect of the invention, said radar tracking filter further is configured to: determine a likelihood function L of the measurement at time t given the present state, and calculate updated state estimate of the tracking filter based upon the predicted state estimate, and the radar measurement information.

According to a further advantageous aspect of the invention, said radar system is located on a marine or aeronautical vehicle.

According to a further advantageous aspect of the invention, the relative orientation of said radar platform with respect to the fixed reference coordinate system is defined by roll, pitch and yaw angles of the radar platform.

### BRIEF DESCRIPTION OF THE DRAWINGS

The present invention will now be described in detail with reference to the figures, wherein:

FIG. 1 shows a radar scanning sphere and two radar measurements at an inclined radar platform with respect to a fixed reference coordinate system X, Y, Z;

FIG. 2 shows the corresponding radar scanning sphere and radar measurements with respect to a local coordinate system X′, Y′, Z′ of the radar antenna and its platform;

FIG. 3 shows a two-dimensional side view of fan-shaped beam;

FIG. 4 shows a flowchart describing the basic steps of the state estimation filter according to an embodiment of the invention; and

FIG. 5 shows the relation between the varying local coordinate system of the radar platform and the fixed horizontal coordinate system.

### DETAILED DESCRIPTION

In the following only one embodiment of the invention is shown and described, simply by way of illustration of one mode of carrying out the invention.

The invention will in the following be explained when applied in a mechanically rotating 2D radar system without servo based motion compensation, and arranged on a radar platform, in particular a marine vessel. The radar uses a fan beam for both transmit and reception of electromagnetic energy, in particular by means of a pulse Doppler radar. The bearing, or azimuth angle, with respect to a local coordinate system of the platform, to a detected target is measured by a sensor providing angle information of the rotating antenna with respect to the stem of the vessel. When the vertical axis of a vessel is orthogonal to the horizontal plane, the target azimuth with respect to a fixed general coordinate system can be determined by adding the angle of the rotating antenna at the moment of return signal with the vessel bearing from north, i.e. the yaw angle.

When the vessel is tilting, the measured angle will depend not only on the target azimuth position, but also on the target's elevation and the relative orientation of the vessel with respect to the horizontal plane. The relative orientation of the vessel in terms of roll, pitch and yaw angle can be measured by means of inertial sensors, for example gyros. The target's elevation and bearing are however not known.

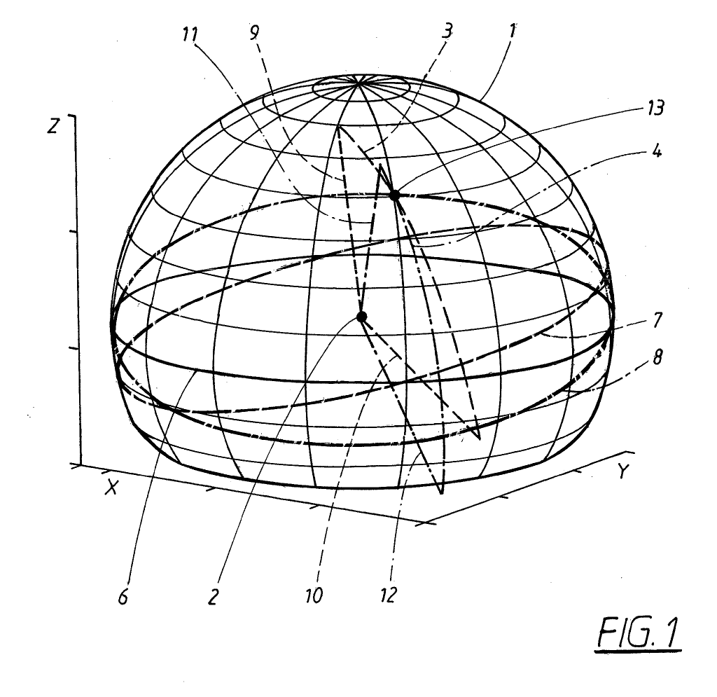

FIG. 1 illustrates the result when tilting the radar platform including the radar antenna with respect to a fixed reference coordinate system, preferably a fixed horizontal coordinate system having three axes, where X and Y form a fixed horizontal plane and Z is orthogonal to the horizontal plane. The radar antenna is here located at the origin 2 of an illustrated radar scanning sphere 1 of a radar platform, which is exposed to roll and pitch motion, i.e. platform motion around the X and Y axis of the horizontal coordinate system. A local coordinate system fixed to the radar platform will thus diverge from the horizontal coordinate system in case of roll and pitch motion. Platform motion around the Z-axis, also called yaw motion, will not cause any errors in the radar tracking system because this type of motion does not diverge the radar antenna's rotation axis from the orthogonal of the horizontal plane.

In FIG. 1, the solid circle 6 represents the fixed horizontal plane, the dashed circle 7 represents the platform orientation of the radar platform at the moment of a first measurement, and the chain-dotted circle 8 represents the platform orientation of the radar platform at the moment of a second measurement. The platform will typically move continuously, and as can be seen in FIG. 1, the platform orientation at the moment of said first and second measurements is diverged from the horizontal coordinate system. A fixed target represented by a point 13 on the radar scanning sphere 1 is detected during said first and second measurement scans, and two radar fan beams 3, 4 are illustrated at the point of time of target detection. Said radar fan beams 3,4 are in the form of first 3 and second 4 circle sectors with their origins 2 at the origin 2 of the radar scanning sphere 1, wherein the first circle sector 3 has a first radius 9, 10 and the second circle sector 4 has a second radius 11, 12.

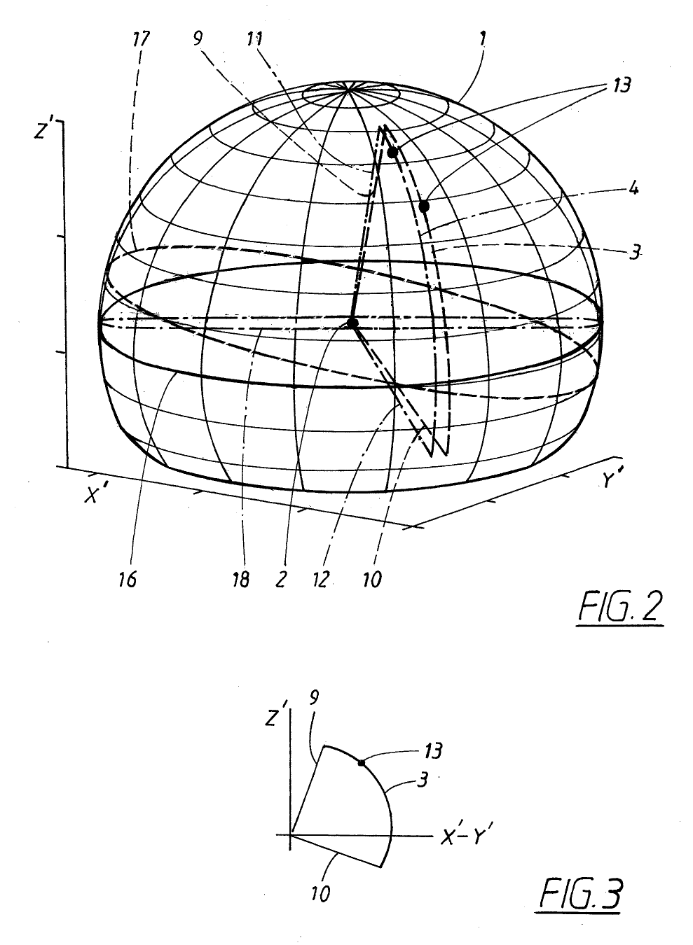

FIG. 2 illustrates the same situation as FIG. 1 but with the measurements fixed according to the local coordinate system X′, Y′, Z′ of the platform instead. The solid circle 16 represents the fixed plane of the radar platform, the dashed circle 17 represents the plane of horizon at the moment of the first measurement, and the chain-dotted circle 18 represents the plane of horizon at the moment of the second measurement. The problem of determining the position of a detected target 13 is thus made clearly visible in FIG. 2, where the first and second scans detect the same target at different radar antenna angles, although the target 13 is fixed in the horizontal coordinate system.

For clarification purposes, a two-dimensional side view of the first fan beam 3 is shown in FIG. 3 at the angle of target detection in a local platform fixed coordinate system X′, Y′ and Z′. The Z′ axis is consequently aligned with the rotation axis of the radar antenna. The first fan beam 3 is relatively tall in the elevation plane Z′ in order to fully cover the air space, also during pitch and roll motion of the antenna.

From the above reasoning, two inventive concepts are derived:
A software-based motion-compensation of a fan-shaped beam 2D-radar antenna can replace a servo based motion-compensation of said antenna, when a target tracking filter is provided with information of the relative orientation of said radar platform with respect to the horizontal coordinate system.
Said radar system can also determine the elevation of a target by conducting a series of measurements of a target, when said measurements are conducted at different relative positions of the radar platform.

Considering that the target illustrated in FIGS. 1-3 is fixed and that the measurements are ideal, and that the target in a realistic scenario is moving and the measurements are inaccurate, it is advantageous to provide a tracking filter to deal with these uncertainties. A requirement on such a tracking filter is that it can handle nonlinear measurements. In the following, a non-limiting embodiment of such a tracking filter is disclosed, which can estimate a target's state taking into account target information from the radar antenna system and motion information of the radar platform.

### Measurement and Coordinate System

Let (x,y,z)^{T} define a north-east-down (NED) Cartesian coordinate system. Introduce a spherical coordinate system relating to the Cartesian coordinate system according to:

$$\{ \begin{matrix}r = \sqrt{{x}^{2} + {y}^{2} + {z}^{2}} \\ ψ = {arctan}_{2} ( y , x ) \\ θ = {arctan}_{2} ( - z , \sqrt{{x}^{2} + {y}^{2}} )\end{matrix} \qquad Equation ( 1 )$$

The function arctan₂ is an extension of the inverse tangent, which also takes into account the quadrant of (x,y) and returns an angle in the interval (−π,π). Let (x′,y′,z′)^{T} define a Cartesian coordinate system fixed to the radar platform, i.e. the marine vessel, where the z′-axis points down through the vessel, the x′-axis points towards the stem, and the y′-axis points towards starboard. A spherical coordinate system can be introduced onto this system similar to equation 1. The spherical coordinate system is defined like (r′,ψ′,θ′). Let g define the transformation between the two coordinate systems such that:

(r′, ψ′, θ′)^{T}=g(r, ψ, θ) Equation (2)

The radar antenna and its signal processing equipment provide target distance information r′ and antenna angle information ψ′ measured from the stem of the vessel in the prime coordinate system. The beam is a fan beam which means that the measurement can be defined according to (r′,ψ′,ξ′), where ξ′ defines the elevation area covered by the fan beam, for example ξ′ε(−π/2,π/2).

Let Z′ represent the measurements. The following is a model of the measurements of this radar:

$${Z}^{′} = N ( ( \begin{matrix}{μ}_{r} \\ {μ}_{ψ}\end{matrix} ) , ( \begin{matrix}{σ}_{r}^{2} & 0 \\ 0 & {σ}_{ψ}^{2} ( θ )\end{matrix} ) ) \qquad Equation ( 3 )$$

It is thus assumed that the measurements in angle and distance are independent. The width of the beam in the ψ-direction varies also with the elevation, which results in that the variance of ψ is a function of θ and thus represented by σ_{ψ}²(θ). In this filter, the measurement is transformed to the horizontal coordinate system according to:

(Z, ξ)=g⁻¹(Z′, ξ′) Equation (4)

### Target Model and Assumptions

When detecting a target, it can be described by a state vector (X(t),Θ(t)) at the time t. Let Zₖ represent the stochastic variable for the observations of (X(tₖ),Θ(tₖ)) at the time tₖ. The result of these observations is represented by zₖ. Let S=Sₓ·S_{θ} define the state space. Let Z(tₖ)=(Z₁, . . . Zₖ) and zₖ=(z₁, . . . , zₖ). These are observations of the target made up until the time tₖ. The distribution function of the target at time tₖ taking into account all the observations made up to this time is defined by:

p(t_{K}, x_{K}, θ_{K})=p(X(t_{K})=x_{K}, Θ(t_{K})=θ_{K},|Z(tₖ)=z_{K}) Equation (5)

After making the following two assumptions:
{(X(t),Θ(t)); t≧0} has Markov property;
Z(tᵢ) and Z(tⱼ) are independent when i≠j given ((X(t₁)=x₁,Θ(t₁)=θ₁), . . . , (X(tₖ)=xₖ,Θ(tₖ)=θₖ));
   equation (5) can be calculated recursively.

Initial distribution:

p(t₀, x₀, θ₀)=q₀(x₀, θ₀), (x₀, θ₀)εSₓ×S_{θ} Equation (6)

### Target Model:

The transfer function q is represented by

qₖ(xₖ, θₖ|xₖ₋₁, θₖ₋₁)=p(X(tₖ)=xₖ, Θ(tₖ)=θₖ|X(tₖ₋₁)=xₖ₋₁, Θ(tₖ₋₁)=θₖ₋₁) Equation (7)

Prediction (a priori):

A priori distribution is calculated by:

p⁻(tₖ, xₖ, θₖ)=∫_{S}_{ₓ} ∫_{S}_{_{θ}} qₖ(xₖ, θₖ|xₖ₋₁, θₖ₋₁)p(tₖ₋₁xₖ₋₁, θₖ₋₁)dθₖ₋₁dxₖ₋₁ Equation (8)

Measurement:

The likelihood function for measurement at time tₖ is represented by

Lₖ(zₖ|θₖ, θₖ)=p(Z(tₖ)=zₖ|X(tₖ)=xₖ, Θ(tₖ)=θₖ), (xₖ, θₖ)εS Equation (9)

Filtering (a posteriori):

By means of the two assumptions made, the equation (5) can be calculated recursively according to:

$$p ( {t}_{k} , {x}_{k} , {θ}_{k} ) = \frac{1}{{c}_{k}} {L}_{k} ( {z}_{k} \vert {x}_{k} , {θ}_{k} ) {p}^{-} ( {t}_{k} , {x}_{k} , {θ}_{k} ) \qquad Equation ( 10 )$$

where cₖ is a normalization constant, such that p(tₖ,.) becomes a distribution function:

cₖ=p(zₖ)=∫_{S}_{ₓ} ∫_{S}_{_{θ}} Lₖ(zₖ|xₖ, θₖ)p⁻(tₖ, xₖ, θₖ)dθₖdxₖ Equation (11)

Until now, it was assumed only one target. When estimating the states of several targets, it simplifies to assume that the other targets do not interfere in the observation of a first target, so called conditional independency, and to assume that the target's trajectories are independent of each other. These two assumptions make it possible to divide association and updating when several targets are tracked.

Tracking of an Air Target This tracking filter will function during motion of the radar platform, as well as without platform motion. If the platform had been non-moving, a 2D-Kalman filter could have been used to estimate the state of the targets. With a moving platform however, the target bearing measurement depends on target elevation and platform orientation. The platform orientation is known, but target elevation is unknown and is not included in the state vector. Target elevation Θ(t) is thus added to the state vector, which now can be written (X(t), Θ(t))^{T}. Let the state vector be defined by a spherical coordinates system having its origin on the vessel according to:

$$( \begin{matrix}X ( {t}_{k} ) \\ Θ ( {t}_{k} )\end{matrix} ) = ( \begin{matrix}R ( {t}_{k} ) \\ \dot{R} ( {t}_{k} ) \\ Ψ ( {t}_{k} ) \\ \dot{Ψ} ( {t}_{k} ) \\ Θ ( {t}_{k} )\end{matrix} ) \qquad Equation ( 12 )$$

Here, ψ denotes azimuth angle instead of φ since φ denotes the transformation matrix, see equation (14). In case the state vector is defined by a cylindrical coordinates system instead, the following state vector is provided:

$$( \begin{matrix}X ( {t}_{k} ) \\ Θ ( {t}_{k} )\end{matrix} ) = ( \begin{matrix}R ( {t}_{k} ) \\ \dot{R} ( {t}_{k} ) \\ Y ( {t}_{k} ) \\ \dot{Y} ( {t}_{k} ) \\ Θ ( {t}_{k} )\end{matrix} ) \qquad Equation ( 13 )$$

A cylindrical coordinate system should be oriented such that the cylinder axis is orthogonal to the direction of the target. To track an air target, a motion model of the target is needed. In case the target is limited to a land- or see based object, or if the radar platform was fixed with respect to the horizontal plane, a two dimensional Kalman filter could have been adopted. But when tracking an air target, also the elevation Θ of the target must be estimated and a three dimensional target motion model will be derived. It is assumed that the targets move in straight trajectories. Hence, the motion model of the target is:

$$( \begin{matrix}X ( {t}_{k} ) \\ Θ ( {t}_{k} )\end{matrix} ) = ( \begin{matrix}{Φ}_{k} & 0 \\ 0 & 1\end{matrix} ) ( \begin{matrix}X ( {t}_{k - 1} ) \\ Θ ( {t}_{k - 1} )\end{matrix} ) + ( \begin{matrix}{b}_{x , k} \\ {b}_{θ , k}\end{matrix} ) + ( \begin{matrix}{w}_{x , k} \\ {w}_{θ , k}\end{matrix} ) \qquad Equation ( 14 )$$

where bₖ is a term reflecting the vessel's own displacement between tₖ₋₁ and tₖ. For spherical coordinates φₖ denotes the Jacobian for a transfer function, which describes a straight trajectory, and bₖ comprises then also constant part of the linearization. The process noise is assumed to follow the normal distribution with expectation value zero, i.e. w_{x,k}˜N(0,Qₖ), and w_{x,θ} has a distribution function denoted h, which is further described later in the text.

The distribution function p(tₖ,xₖ,θₖ):

In case the vessel does not experience any relative motion with respect to the horizontal coordinate system, p(tₖ,xₖ) would have normal distribution. However, in case the vessel does experience relative motion, said distribution no longer applies. To calculate p(tₖ,xₖ,θₖ), it would be possible to discretize Sₓ and S_{θ}. This approach would however need too much computational effort to achieve required accuracy. Instead, it is possible to limit the discretization to N discrete intervals in the θ-direction only, where Bⱼ denotes these intervals, and where |Bⱼ| is the length of said interval Bⱼ. The discretization is selected such that S_{θ}=UⱼBⱼ. The distribution function θₖ→p(tₖ,xₖ,θₖ) is thus assumed to be piecewise constant for each interval. In the remaining coordinates, the distribution function xₖ→p(tₖ,xₖ,θₖ) is assumed to have normal distribution. The distribution function is thus defined according to:

$$p ( {t}_{k} , {x}_{k} , {θ}_{k} ) = {\sum }_{j = 1}^{N} η ( {x}_{k} , {μ}_{x , k}^{j} , {Σ}_{x , k}^{j} ) \cdot \frac{1}{\vert {B}_{j} \vert} {P}_{θ , k}^{j} \cdot χ {B}_{j} ( {θ}_{k} ) \qquad Equation ( 15 )$$

Here, ηᵢ(x,μΣ) the normal distribution with expectation value μ and variance Σ. P_{θ}^{j} denotes the likelihood that the target is within the interval Bⱼ, and μₑ^{j} defines the centre of the interval Bⱼ. The marginal distributions are defined by the following two equations:

$$\begin{matrix}\begin{matrix}p ( {t}_{k} , {x}_{k} ) = {\int }_{{S}_{θ}}^{ } p ( {t}_{k} , {x}_{k} , {θ}_{k} ) d {θ}_{k} \\ = {\sum }_{j = 1}^{N} η ( {x}_{k} , {μ}_{x , k}^{j} , {Σ}_{x , k}^{j} ) \cdot {P}_{θ , k}^{j}\end{matrix} & Equation ( 16 ) \\ \begin{matrix}p ( {t}_{k} , {θ}_{k} ) = {\int }_{{S}_{x}}^{ } p ( {t}_{k} , {x}_{k} , {θ}_{k} ) d {x}_{k} \\ = {\sum }_{j = 1}^{N} \frac{{P}_{θ , k}^{j}}{\vert {B}_{j} \vert} χ {B}_{j} ( θ )\end{matrix} & Equation ( 17 )\end{matrix}$$

The target location is measured by the radar in spherical coordinates (range, azimuth). Tracking in spherical coordinates is however difficult since motion of constant velocity targets (straight lines) will cause acceleration terms in all coordinates. A simple solution to this problem is to track in horizontal coordinates. Hence, the measurement of the target position is transformed to the horizontal coordinate system. Since only distance and detection angle are measured, the measurement will cross several different intervals Bⱼ. For each measured interval, ψ^{j} must be determined. This is performed by adding a third coordinate to the measurement μ′_{θ}^{j}, and by selecting this such that the transformed measurement lies on the elevation μ_{θ}^{j}. Since g is a bijection, there is single μ′_{θ}^{j} that fulfils this. Hence, according to equation (4):

(z^{j}, μ_{θ}^{j})=g⁻¹(z′^{j}, μ′_{θ}^{j}) Equation (18)

Equation (18) is used to determine the likelihood function for the measurement. Now, all necessary assumptions are ready, and in the following, prediction and filtering will be derived. Prediction is performed according to equation (14) by:

qₖ(xₖ, θₖ|xₖ₋₁, θₖ₋₁)=Σⱼ₌₁^{N}η(xₖ, φₖxₖ₋₁+b_{x,k}^{j}, Q_{x,k}^{j})·h(θₖ, θₖ₋₁+b_{θ,k}^{j}, Q_{θ,k}^{j})χBⱼ(θₖ₋₁) Equation (19)

Here, b_{x,k}^{j} denotes a distance traveled by the own vessel plus an additional linearization contribution in case the target is tracked by means of spherical coordinates. In an analogue manner, b_{θ,k}^{j} denotes a term for the distance moved of the origin of the coordinate system due to the motion of the own vessel, and h denotes a function of the target in the elevation direction. θₖ₋₁+b_{θ,k}^{j} denotes the expectation value, and Q_{θ,k}^{j} denotes some type of diffusion term depending on choice of function. For example, the following function defines target elevation motion in case said target moves according to a uniform distribution:

$$h ( {θ}_{k} , {θ}_{k - 1} + {b}_{θ , k}^{j} , {Q}_{θ , k}^{j} ) = \frac{1}{\vert {D}_{j} \vert} χ {D}_{j} ( {θ}_{k} - ( {θ}_{k - 1} + {b}_{θ , k}^{j} ) ) \qquad Equation ( 20 )$$

The length of the interval |Dⱼ| depends on the target maximum speed in elevation direction.

A state estimation prediction can now be made in two steps. For all directions except θ-direction, q describes the update for a normal Kalman filter:

p⁻(tₖ,xₖ, θₖ)=∫_{S}_{ₓ}∫_{S}_{_{θ}}qₖ(xₖ, θₖ|xₖ₋₁, θₖ₋₁)p(tₖ₋₁xₖ₋₁, θₖ₋₁)dθₖ₋₁dxₖ₋₁=Σⱼ₌₁^{N} ∫_{S}_{ₓ} ∫_{S}_{_{θ}}η(xₖ, φₖxₖ₋₁+b_{x,k}^{k}, Q_{x,k}^{j})·h(θₖ, θₖ₋₁+b_{θ,k}^{j}, Q_{θ,k}^{j})·η(xₖ₋₁, μ_{x,k-1}^{j}, Σ_{x,k-1}^{j})·1/|bⱼ|P_{θ,k-1}^{j}·χBⱼ(θₖ₋₁)dθₖ₋₁dxₖ₋₁=Σⱼ₌₁^{N} ∫_{S}_{_{θ}} η(xₖ, \tilde{μ}_{x,k}^{-,j}, \tilde{Σ}_{x,k}^{-,j})1/|Bⱼ|P_{θ,k-1}^{j}χBⱼ(θₖ₋₁)·h(θₖ, θₖ₋₁+b_{θ,k}^{j}, Q_{θ,k}^{j})dθₖ₋₁ Equation (21)

The variables marked with tilde are those received by the Kalman filter for X|(ΘεBⱼ), i.e.:

\tilde{μ}_{x,k}^{-,j}=φₖμ_{x,k-1}+b_{x,k}^{j} Equation (22)

\tilde{Σ}_{x,k}^{-,j}=φₖΣ_{x,k-1}^{j}φₖ^{T}+Q_{x,k}^{j} Equation (23)

Assuming h according (20), then (21) will have the form:

$${p}^{-} ( {t}_{k} , {x}_{k} , {θ}_{k} ) = {\sum }_{j = 1}^{N} η ( {x}_{k} , {\tilde{μ}}_{x , k}^{- , j} , {\tilde{Σ}}_{x , k}^{- , j} ) {P}_{θ , k - 1}^{j} \frac{1}{\vert {B}_{j} \vert \vert {D}_{j} \vert} χ {B}_{j} * χ {D}_{j} ( {θ}_{k} - {b}_{θ , k}^{j} ) \qquad Equation ( 24 )$$

This function must be approximated with a function piecewise constant in the θ-direction, and having a normal distribution in remaining directions, i.e. a function like (15). By introducing the term aᵢⱼ according to:

$${\int }_{{B}_{i}}^{ } {p}^{-} ( {t}_{k} , {x}_{k} , {θ}_{k} ) d {θ}_{k} = {\sum }_{j = 1}^{N} η ( {x}_{k} , {\tilde{μ}}_{x , k}^{- , j} , {\tilde{Σ}}_{x , k}^{- , j} ) {P}_{θ , k - 1}^{j} \cdot {a}_{ij} \qquad Equation ( 25 )$$

Said term aᵢⱼ represents the likelihood for transfer between different intervals, i.e. the probability that a target within interval Bⱼ should have moved to interval Bᵢ since the last measurement at tₖ₋₁. The distribution is received by:

$$\begin{matrix}{P}_{θ , k}^{- , i} = {\int }_{{S}_{x}}^{ } {\int }_{{B}_{i}}^{ } {p}^{-} ( {t}_{k} , {x}_{k} , {θ}_{k} ) d {θ}_{k} d {x}_{k} \\ = {\sum }_{j = 1}^{N} {P}_{θ , k - 1}^{j} \cdot {a}_{ij}\end{matrix} \qquad Equation ( 26 )$$

The expectation values are received by:

$$\begin{matrix}{P}_{θ , k}^{- , i} \cdot {μ}_{x , k}^{- , i} = {\int }_{{S}_{x}}^{ } {\int }_{{B}_{i}}^{ } {x}_{k} {p}^{-} ( {t}_{k} , {x}_{k} , {θ}_{k} ) d {θ}_{k} d {x}_{k} \\ = {\sum }_{j = 1}^{N} {\tilde{μ}}_{x , k}^{- , j} {P}_{θ , k - 1}^{j} \cdot {a}_{ij}\end{matrix} \qquad Equation ( 27 )$$

Finally, the covariance matrixes are calculated by:

$$\begin{matrix}{P}_{θ , k}^{- , i} \cdot {Σ}_{x , k}^{- , i} = {\int }_{{S}_{x}}^{ } {\int }_{{B}_{i}}^{ } ( {x}_{k} - {μ}_{x , k}^{- , i} ) {( {x}_{k} - {μ}_{x , k}^{- , i} )}^{T} \\ {p}^{-} ( {t}_{k} , {x}_{k} {θ}_{k} ) d {θ}_{k} d {x}_{k} \\ = {\int }_{{S}_{x}}^{ } {\int }_{{B}_{i}}^{ } ( {x}_{k} - {\tilde{μ}}_{x , k}^{- , j} + ( {\tilde{μ}}_{x , k}^{- , j} - {μ}_{x , k}^{- , i} ) ) \\ {( {x}_{k} - {\tilde{μ}}_{x , k}^{- , j} + ( {\tilde{μ}}_{x , k}^{- , j} - {μ}_{x , k}^{- , i} ) )}^{T} {p}^{-} ( {t}_{k} , {x}_{k} , {θ}_{k} ) \\ d {θ}_{k} d {x}_{k} \\ = {\sum }_{j = 1}^{N} {a}_{ij} {P}_{θ , k - 1}^{j} \cdot [ {\tilde{Σ}}_{x , k}^{- , j} + ( {\tilde{μ}}_{x , k}^{- , j} - {μ}_{x , k}^{- , i} ) \\ {( {\tilde{μ}}_{x , k}^{- , j} - {μ}_{x , k}^{- , i} )}^{T} ]\end{matrix} \qquad Equation ( 28 )$$

At this point, the a priori distribution has been determined and a measurement based state estimate update can be performed: State estimate updates shall be performed using (10). Let zₖ^{j} denote the measurement at time point tₖ transferred to the coordinate system used for state estimation of the target. The calculation of zₖ^{j} is determined by (18). Let Rₖ^{j} be the covariance matrix for the transferred measurement. Due to the orientation of the vessel, and the limited elevation coverage of the radar antenna, a measurement can not always be transferred to all Bⱼ. Let Aₖ denote the subset of {1, . . . , N} where measurements are available:

Aₖ={jε{1, . . . , N}; ∃zₖ^{j}, θ′ₖ^{j} lies within the antenna coverage} Equation (29)

The likelihood function Lₖ is according the measurement model defined according to:

$${L}_{k} ( {z}_{k} \vert {x}_{k} , {θ}_{k} ) = {\sum }_{j ∈ {A}_{k}} η ( {z}_{k}^{j} , M {x}_{k} , {R}_{k}^{j} ) {χ}_{{B}_{j}} ( θ ) \qquad Equation ( 30 )$$

The update will then have the form:

$$p ( {t}_{k} , {x}_{k} , {θ}_{k} ) = \frac{1}{c} {L}_{k} ( {z}_{k} \vert {x}_{k} , {θ}_{k} ) {p}^{-} ( {t}_{k} , {x}_{k} , {θ}_{k} ) \qquad Equation ( 31 )$$

Since the distribution function is piecewise constant in θ, this can be written as:

$$\begin{matrix}p ( {t}_{k} , {x}_{k} , {θ}_{k} ) = {\sum }_{j ∈ {A}_{k}} η ( {x}_{k} , {μ}_{x , k}^{j} , {\sum }_{x , k}^{j} ) \cdot \frac{1}{\vert {B}_{j} \vert} {P}_{θ , k}^{j} \cdot {χ}_{{B}_{j}} ( θ ) \\ = \frac{1}{c} {\sum }_{j ∈ {A}_{k}} η ( {z}_{k}^{j} , M {x}_{k} , {R}_{k}^{j} ) η ( {x}_{k} , {μ}_{x , k}^{- , j} , {Σ}_{x , k}^{- , j} ) \cdot \\ \frac{1}{\vert {B}_{j} \vert} {P}_{θ , k}^{- , j} \cdot {χ}_{{B}_{j}} ( θ )\end{matrix} \qquad Equation ( 32 )$$

The calculation of (32) is made in two steps. Firstly, each interval Bⱼ can be calculated separately by (32). The normalization c is determined starting from:

η(xₖ, μ_{x,k}^{j}, Σ_{x,k}^{j})cⱼ=η(zₖ, Mxₖ, Rₖ^{j})η(xₖ, μ_{x,k}^{-,j}, Σ_{x,k}^{-,j}) Equation (33)

This is a normal update of a Kalman filter. To determine cⱼ, which is needed to determine the new distribution in θ-direction, one starts out with the following identity (Bayes rule):

p(xₖ|zₖ^{j})p(zₖ^{j})=p(zₖ^{j}|ₖ)p(xₖ) Equation (34))

Both p(xₖ|zₖ^{j}) and p(zₖ^{j}) must be determined. The term p(xₖ|zₖ^{j}) is known from the Kalman filter update, and thus already described in many sources, and can be derived by the well-known “matrix inversion lemma”. The term p(xₖ|zₖ^{j})=cⱼ is needed to determine c together with

$$\frac{1}{\vert {B}_{j} \vert} {P}_{θ , k}^{- , j} .$$

The transferred measurement can thus be described by Zₖ^{j}=MX(tₖ)+εₖ^{j}, where εₖ^{j}˜N(0,Rₖ^{j}). This gives E[Zₖ^{j}]=Mμ_{x,k}^{-,j} and Var[Zₖ^{j}]=MZ_{x,k}^{-,j}M^{T}+Rₖ^{j}. Hence:

p(zₖ^{j})=η(zₖ^{j}, Mμ_{z,k}^{-,j}, Sₖ^{j}) Equation (35)

where

Sₖ^{j}=MΣ_{x,k}^{-,j}M^{T}+Rₖ^{j} Equation (36)

New expectation values and covariance matrixes can now be calculated by:

μ_{x,k}^{j}=μ_{x,k}^{-,j}+Σ_{x,k}^{-,j}M^{T}(S^{j})⁻¹(zₖ^{j}−Mμ_{z,k}^{-,j}) Equation (37)

and

Σ_{x,k}^{j}=Σ_{x,k}^{-,j}−Σ_{x,k}^{-,j}M^{T}(S^{j})⁻¹MΣ_{x,k}^{-,j} Equation (38)

Finally, P_{θ,k}ⁱ will be calculated. First, the normalization constant c is determined by introducing (33) and (35) in equation (32) and integrating over (Sₓ×S_{θ}):

$$\begin{matrix}{\int }_{{S}_{x}} {\int }_{{S}_{θ}} cp ( {t}_{k} , {x}_{k} , {θ}_{k} ) d {θ}_{k} d {x}_{k} = {\int }_{{S}_{x}} {\int }_{{S}_{θ}} {Σ}_{j ∈ {A}_{k}} η ( {z}_{k}^{j} , M {μ}_{x , k}^{- , j} , {S}_{k}^{j} ) η ( {x}_{k} , {μ}_{x , k}^{j} , {Σ}_{x , k}^{j} ) \cdot \frac{1}{\vert {B}_{j} \vert} {P}_{θ , k}^{- , j} \cdot {χ}_{{B}_{j}} ( θ ) d {θ}_{k} d {x}_{k} ⇔ & ( 39 ) \\ c = {Σ}_{j ∈ {A}_{k}} η ( {z}_{k}^{j} , M {μ}_{x , k}^{- , j} , {S}_{k}^{j} ) {P}_{θ , k}^{- , j} & ( 40 )\end{matrix}$$

Now, P_{θ,k}ⁱ can be calculated by integrating over Bᵢ in equation (39) instead of S_{θ}. Then, P_{θ,k}ⁱ is calculated according to:

$${P}_{θ , k}^{i} = \frac{{P}_{θ , k}^{- , i} η ( {z}_{k}^{i} , M {μ}_{x , k}^{- , i} , {S}^{i} )}{{Σ}_{j ∈ {A}_{k}} {P}_{θ , k}^{- , j} η ( {z}_{k}^{j} , M {μ}_{x , k}^{- , j} , {S}^{j} )} \qquad ( 41 )$$

This ends the state estimation update and the result can be presented. It is possible to calculate the expectation value of (X(tₖ)^{T}, Θ(tₖ))^{T} by first calculating μ_{θ,k}:

$$\begin{matrix}{μ}_{θ , k} = {\int }_{{S}_{x}} {\int }_{{S}_{θ}} {θ}_{k} p ( {t}_{k} , {x}_{k} , {θ}_{k} ) d {θ}_{k} d θ {x}_{k} \\ = {\sum }_{j = 1}^{N} {\int }_{{S}_{θ}} {θ}_{k} {P}_{θ , k}^{j} \cdot \frac{1}{\vert {B}_{j} \vert} \cdot {χ}_{{B}_{j}} ( θ ) d {θ}_{k} \\ = {\sum }_{j = 1}^{N} {μ}_{θ , k}^{j} {P}_{θ , k}^{j}\end{matrix} \qquad ( 42 )$$

and subsequently μ_{x,k}:

$$\begin{matrix}{μ}_{x , k} = {\int }_{{S}_{x}} {\int }_{{S}_{θ}} {x}_{k} p ( {t}_{k} , {x}_{k} , θ ) d {θ}_{k} d {x}_{k} \\ = {\sum }_{j = 1}^{N} {\int }_{{S}_{θ}} {μ}_{x , k}^{j} {P}_{θ , k}^{j} \cdot \frac{1}{\vert {B}_{j} \vert} \cdot {χ}_{{B}_{j}} ( θ ) d {θ}_{k} \\ = {\sum }_{j = 1}^{N} {μ}_{x , k}^{j} {P}_{θ , k}^{j}\end{matrix} \qquad ( 43 )$$

In certain situations, it might also be of interest to obtain the covariance matrix:

$$\begin{matrix}Var [ ( \begin{matrix}X ( {t}_{k} ) \\ Θ ( {t}_{k} )\end{matrix} ) ] = {\int }_{{S}_{x}} {\int }_{{B}_{i}} ( ( \begin{matrix}{x}_{k} \\ {θ}_{k}\end{matrix} ) - ( \begin{matrix}{μ}_{x , k} \\ {μ}_{θ , k}\end{matrix} ) ) {( ( \begin{matrix}{x}_{k} \\ {θ}_{k}\end{matrix} ) - ( \begin{matrix}{μ}_{x , k} \\ {μ}_{θ , k}\end{matrix} ) )}^{T} \cdot \\ p ( {t}_{k} , {x}_{k} , {θ}_{k} ) d {θ}_{k} d {x}_{k} \\ = {\sum }_{j = 1}^{N} {P}_{θ , k}^{j} ( \begin{matrix}\begin{matrix}{Σ}_{x , k}^{j} + ( {μ}_{x , k}^{j} - {μ}_{x , k} ) \\ {( {μ}_{x , k}^{j} - {μ}_{x , k} )}^{T}\end{matrix} & \begin{matrix}( {μ}_{x , k}^{j} - {μ}_{x , k} ) \\ ( {μ}_{θ , k}^{j} - {μ}_{θ , k} )\end{matrix} \\ \begin{matrix}( {μ}_{θ , k}^{j} - {μ}_{θ , k} ) \\ {( {μ}_{x , k}^{j} - {μ}_{x , k} )}^{T}\end{matrix} & \begin{matrix}{\vert {B}_{j} \vert}^{2} / 12 + \\ {( \begin{matrix}{μ}_{θ , k}^{j} - \\ {μ}_{θ , k}\end{matrix} )}^{2}\end{matrix}\end{matrix} )\end{matrix} \qquad Equation ( 41 )$$

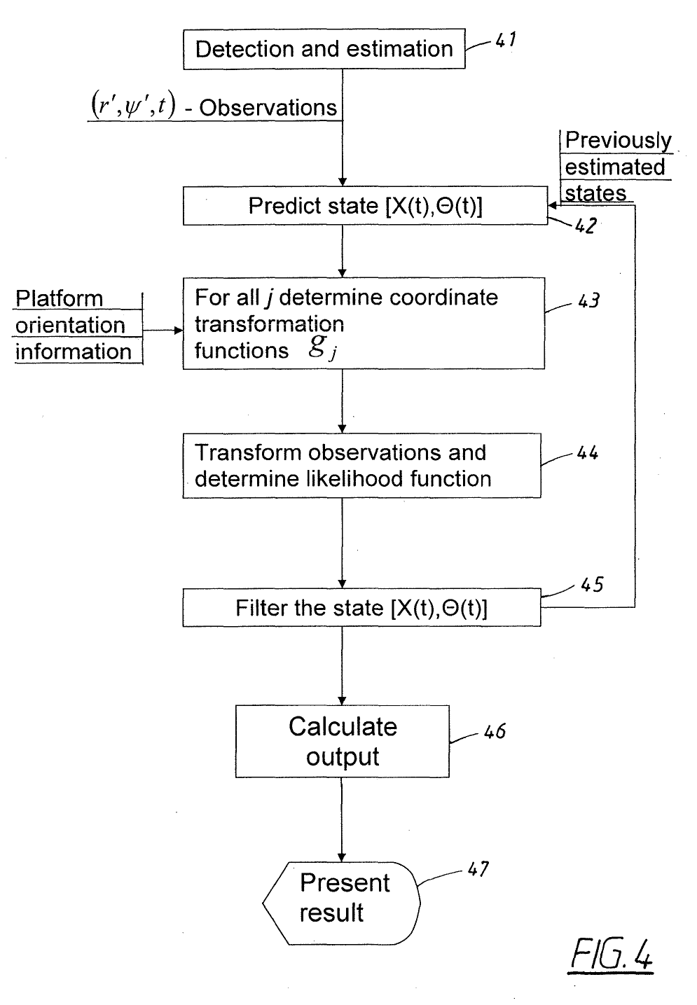

Equation (41) ends the derivation of a tracking filter, which is suitable to be implemented in a radar system. The steps and equations needed to transform the radar measurement to an output display unit are presented below in relation to the flowchart of FIG. 4, which illustrates the basic steps of the calculation according to the inventive method.

In a first step 41, the radar antenna system performs signal processing on the return signals received by the radar antenna. If a target is detected, its target parameters are estimated based upon the return signal. The target parameters included in this embodiment are: distance to target(r′), target detection angle (ψ′), and point of time of the return signal corresponding to said target detection. Said target parameters (r′,ψ′,t) are determined in the local platform based coordinate system of the radar system, and are subsequently transferred to step 42.

In a second step 42, a state estimation prediction of the state variables of the Kalman filter is performed at the current time step based on the previous estimated state of the filter. Equations (22), (23), (26), (27) and (28) determine said state estimation prediction, and they are summarized below:

\tilde{μ}_{x,k}^{-,j}=φₖμ_{x,k-1}+b_{x,k}^{j}

\tilde{Σ}_{x,k}^{-,j}=φₖΣ_{x,k-1}^{j}φₖ^{T}+Q_{x,k}^{j}

Determine the transfer likelihood terms aᵢⱼ according to (25), where P_{θ,k}^{-,j} is the elevation distribution:

$${P}_{θ , k}^{- , i} = {\sum }_{j = 1}^{N} {P}_{θ , k - 1}^{j} \cdot {a}_{ij}$$

Expectation values μ_{x,k}^{-,j}:

$${P}_{θ , k}^{- , i} \cdot {μ}_{x , k}^{- , i} = {\sum }_{j = 1}^{N} {\tilde{μ}}_{x , k}^{- , j} {P}_{θ , k - 1}^{j} \cdot {a}_{ij}$$

Covariance matrixes Σ_{x,k}^{-,j}:

$${P}_{θ , k}^{- , i} \cdot {Σ}_{x , k}^{- , i} = {\sum }_{j = 1}^{N} {a}_{ij} {P}_{θ , k - 1}^{j} \cdot [ {\tilde{Σ}}_{x , k}^{- , j} + ( {\tilde{μ}}_{x , k}^{- , j} - {μ}_{x , k}^{- , j} ) {( {\tilde{μ}}_{x , k}^{- , j} - {μ}_{x , k}^{- , i} )}^{T} ]$$

In step 43, coordinate transfer functions gⱼ are determined for all j, wherein j denotes the discretiziced intervals of the radar coverage in θ-direction, i.e. the elevation direction in the horizontal coordinate system. Bⱼ denotes said intervals. Said coordinate transfer functions gⱼ transform each measurement (r′,ψ′,t) of the local platform based coordinate system to (r,ψ,Θⱼ,t) of the horizontal coordinate system for all different Θⱼ. Information of vessel orientation (pitch, roll and yaw) at the point of time t is necessary to derive these transformations, which orientation is obtained for example by an inertial navigation system of the radar platform.

In step 44, the radar observation of step 41 is transformed using the transfer functions gⱼ, and the corresponding likelihood function L of the measurement at time t is determined given the present state.

In step 45, a state estimation update of the state variables is performed based upon the predicted state estimate of the target, and the radar measurement information. Equations (36), (37), (38) and (41) determine said calculations of the filtering, and they are summarized below: Expectation values μ_{x,k}^{j}:

μ_{x,k}^{j}=μ_{x,k}^{-,j}+Σ_{x,k}^{-,j}M^{T}(S^{j})⁻¹(zₖ^{j}−Mμ_{x,k}^{-,j})

and covariance matrixes Σ_{x,k}^{j}:

Σ_{x,k}^{j}=Σ_{x,k}^{-,j}−Σ_{x,k}^{-,j}M^{T}(S^{j})−1MΣ_{x,k}^{-,j}

where

Sₖ^{j}=MΣ_{x,k}^{-,j}M^{T}+Rₖ^{j}

Elevation distribution, P_{θ,k}ⁱ:

$${P}_{θ , k}^{i} = \frac{{P}_{θ , k}^{- , i} η ( {z}_{k}^{i} , M {μ}_{x , k}^{- , i} , {S}^{i} )}{{\sum }_{j = 1}^{N} {P}_{θ , k}^{- , j} η ( {z}_{k}^{j} , M {μ}_{x , k}^{- , j} , {S}^{j} )}$$

In step 46, the result of the filtering can be derived by calculating: expectation value:

$$E [ ( \begin{matrix}X ( {t}_{k} ) \\ Θ ( {t}_{k} )\end{matrix} ) ] = {\sum }_{j = 1}^{N} {P}_{θ , k}^{j} ( \begin{matrix}{μ}_{x , k}^{j} \\ {μ}_{θ , k}^{j}\end{matrix} )$$

And variance:

$$Var [ ( \begin{matrix}X ( {t}_{k} ) \\ Θ ( {t}_{k} )\end{matrix} ) ] = {\sum }_{j = 1}^{N} {P}_{θ , k}^{j} ( \begin{matrix}{\sum }_{x , k}^{j} + ( {μ}_{x , k}^{j} - {μ}_{x , k} ) {( {μ}_{x , k}^{j} - {μ}_{x , k} )}^{T} & ( {μ}_{x , k}^{j} - {μ}_{x , k} ) ( {μ}_{θ , k}^{j} - {μ}_{θ , k} ) \\ ( {μ}_{θ , k}^{j} - {μ}_{θ , k} ) {( {μ}_{x , k}^{j} - {μ}_{x , k} )}^{T} & {\vert {B}_{j} \vert}^{2} / 12 + {( {μ}_{θ , k}^{j} - {μ}_{θ , k} )}^{2}\end{matrix} )$$

Finally, in step 47, the calculated result can be presented by any suitable means, for example on a display.

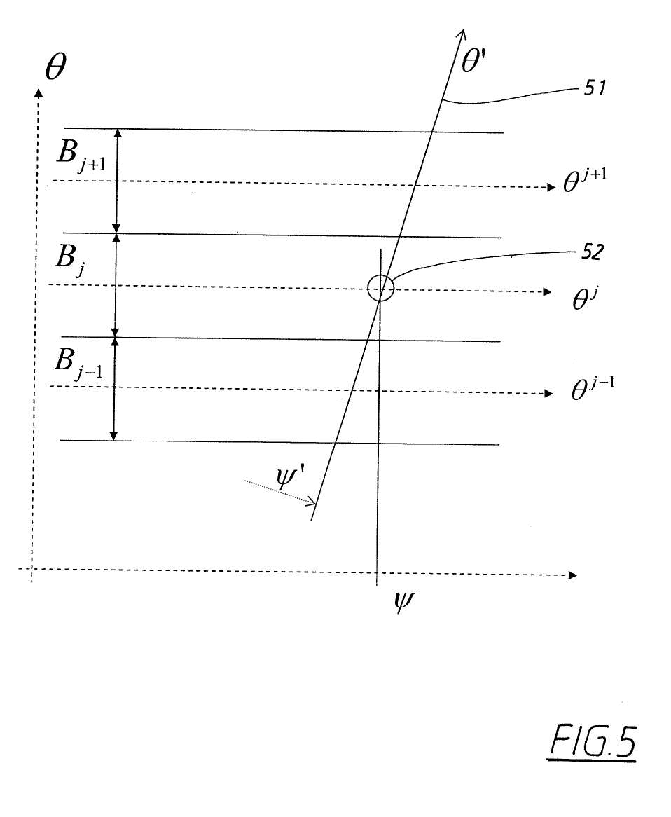

In FIG. 5, the varying local coordinate system of the radar platform ψ′, θ′, as well as the static horizontal coordinate system ψθ is illustrated, and how they correlate. The radar system makes observations of a target in local platform based coordinate system. The parameters of a detected target for a 2D fan beam radar are the target distance r′, and the target bearing ψ′. No information is however available about the elevation θ′. Hence, target bearing ψ′ in the local coordinate system is extended 51 in the elevation direction to indicate all possible elevation locations of said target within the elevation scope of the radar beam, all having the identical target bearing ψ′ in the local coordinate system. Note here that elevation direction of the radar platform orientation θ′ differs from the elevation direction of the horizontal coordinate system θ, because of the movement of the vessel on which the radar antenna is located. Said elevation scope of the radar beam is subsequently divided into N discrete intervals Bⱼ, j=1 . . . N by the tracking filter in elevation direction of the horizontal coordinate system θ, such that the union of Bⱼ covers the entire elevation scope. The centre of each said interval Bⱼ is denoted θⱼ. Given that a target is located at elevation θⱼ, the bearing ψ of the target in the horizontal coordinate system can be estimated. A set of estimations ψ|θⱼ for j=1 . . . N are thus provided. The circle 52 indicates the relationship between ψ′ and ψ|θⱼ.

When the platform does not move, the measured angle will be the same in all elevation bands, Bⱼ, which updates the tracking filter. The tracking filter will thus work as a 2D Kalman filter in such a situation.

To increase accuracy, uniform discretization should be avoided. The points of discretizations should be selected to such that that they lie more dense where P_{θ,k}ⁱ is high and less dense where P_{θ,k}ⁱ is small. This can be achieved after each filtering loop for example by dividing those intervals Bᵢ in two parts, which corresponds to P_{θ,k}ⁱ>threshold.

The calculations described above will only be performed for those intervals Bⱼ where P_{θ,k}^{j}≠0.

### Tracking of a Sea- or Land Based Target

Since sea and land based targets do not move in the elevation direction, the target elevation is always known. Due to this, equation (4) can be used to transform the measurement to a horizontal coordinate system, wherein a known ξ′ implies that ξ=0. Hence, the measurement Z′ can be transferred to horizontal coordinate system according to:

(Z, 0)=g⁻¹(Z′,ξ′) Equation (44)

The state of the target can now be estimated by means of a 2D Kalman filter.

The disclosed radar system can simultaneously track multiple targets, and the invention is capable of modification in various obvious respects, all without departing from the scope of the appended claims. Accordingly, the drawings and the description thereto are to be regarded as illustrative in nature, and not restrictive.

The term relative orientation of the radar platform is throughout this disclosure considered to represent the relative orientation of the radar platform's local coordinate system with respect to said horizontal coordinate system. The relative orientation is defined in terms of roll, pitch and yaw angles.

Pitch, roll and yaw angles measure the absolute attitude angles of a vessel relative to the horizon/true north. These are defined as:

Pitch angle: Angle of x′-axis of the vessel relative to horizon;
Roll angle: Angle of y′-axis of the vessel relative to horizon;
Yaw angle: Angle of x′-axis of the vessel relative to North;
where the x′-axis points towards the stem of the vessel, and the y′-axis points towards starboard of the vessel.

The term radar platform is considered to signify a vehicle body, for example a marine vessel or an aircraft, which rotatably supports a radar antenna. In case the radar antenna is stabilized by a servo based motion compensating support as in the prior art, the rotating axis of the radar antenna will constantly be substantially orthogonal to the horizontal plane despite platform roll and pitch motion. In case of a pure software-based motion-compensation of the antenna according to the invention however, the rotating axis of the radar antenna will constantly be substantially parallel to the z-axis of the vehicle, i.e. the radar antenna will have a varying relative orientation with respect to the horizontal coordinate system in case of platform roll and pitch motion.

The term “narrow-fan type radar” is considered to represent a radar system having an antenna, which produces a main beam having a narrow beam width in the horizontal plane, often around 1°, and a wider beam width in the vertical plane, in particular 20°-100°.

1. A radar system for detecting and tracking at least one target utilizing a mechanically rotated two-dimensional radar antenna system with a fan-shaped beam, arrangeable on a non-stable radar platform, the radar system comprising:
a tracking filter configured to estimate an azimuth angle of said at least one target with respect to a fixed reference coordinate system, based on:
azimuth angle information of at least one target radar return signal measured by means of said radar antenna system with respect to a local coordinate system of said radar platform,
radar platform relative orientation with respect to said fixed reference coordinate system at the time of said at least one target radar return signal,
such that a software-based motion-compensation of said radar platform is provided,
wherein said tracking filter is configured to estimate the elevation of said at least one target in said fixed reference coordinate system by iteratively updating a target elevation estimation by means of said tracking filter based on at least two target radar return signals, each received during separate radar measurement scans of the same target, and each received at a different relative orientation of the radar platform.

2. The radar system according to claim 1, further comprising:
a radar platform,
a mechanically rotated 2D-radar antenna system arranged on said radar platform, and configured to generate a fan-shaped beam, and to measure azimuth angle information of at least one target radar return signal with respect to a local coordinate system of said radar platform, and
radar platform orientation sensors configured to provide said radar platform relative orientation with respect to said fixed reference coordinate system.

3. The radar system according to claim 1, wherein said radar platform orientation sensors comprise at least one of inertial sensors, accelerometers, gyroscopes, inclinometers, or an inertial navigation system, for providing the relative orientation of said radar platform with respect to said fixed reference coordinate system.

4. The radar system according to claim 1, wherein the radar tracking filter is a nonlinear state estimation filter or a particle filter.

5. A method for detecting and tracking at least one target utilizing a mechanically rotated two-dimensional radar antenna system with a fan-shaped beam, arrangeable on a platform, the method comprising:
obtaining azimuth angle information of at least one target radar return signal measured by said radar antenna system with respect to a local coordinate system of said radar platform,
obtaining radar platform relative orientation with respect to a fixed reference coordinate system at the time of said at least one target radar return signal,
estimating an azimuth angle of said at least one target with respect to said fixed reference coordinate system utilizing a tracking filter, based on said azimuth angle information and said radar platform relative orientation, such that a software-based motion-compensation of said radar platform is provided, and
estimating the elevation of said at least one target in said fixed reference coordinate system utilizing said tracking filter, by iteratively updating a target elevation estimation utilizing said tracking filter based on at least two target radar return signals, each received during separate radar measurement scans of the same target, and each received at a different relative orientation of the radar platform.

6. The method according to claim 5, wherein the relative orientation of said radar platform with respect to the fixed reference coordinate system is defined by roll, pitch and yaw angles of the radar platform.

7. The method according to claim 5, wherein the relative orientation of said radar platform with respect to the fixed reference coordinate system is obtained utilizing inertial sensors, accelerometers, gyroscopes, inclinometers, or an inertial navigation system.

8. The method according to claim 5, wherein the measurement model of the tracking filter defines the state space of at least one detectable target, and a distribution function of said at least one target at time taking into account all radar return signals measurements made up to this time, wherein S_{θ} is discretized to discrete intervals in a vertical-direction of a fixed horizontal coordinate system, where Bⱼ denotes these intervals, such that S_{θ}=UⱼBⱼ.

9. The method according to claim 8, wherein the discretization is denser where the elevation distribution is high and less dense where the elevation distribution is small.

10. The method according to claim 5, wherein obtaining azimuth angle information of at least one target radar return signal comprises:
measuring target parameters in said local coordinate system of said radar platform, and
transferring said target parameters to said tracking filter, which is configured to produce an estimate of the state at the current time step based on a state estimate from a previous time step.

11. The method according to claim 5, wherein estimating said azimuth angle of said at least one target utilizing said tracking filter comprises:
determining coordinate transfer functions gⱼ for all j, and
transforming measured target parameters in said local coordinate system to target parameters in the fixed reference coordinate system for all different Θⱼ utilizing said coordinate transfer functions gⱼ.

12. The method according to claim 5, wherein estimating said azimuth angle of said at least one target utilizing said tracking filter further comprises:
determining a likelihood function L of the measurement at time t the present state, and
calculating the updated state estimate based upon the predicted state estimate of the target motion, and the radar measurement information.
